(19) United States
(12) Patent Application Publication
(10) Pub. No.: US 2024/0359280 A1
(43) Pub. Date: Oct. 31, 2024

(54) ONE PIECE TOOLING APPARATUS

(71) Applicant: ENGINEERED ABRASIVES, INC., Alsip, IL (US)

(72) Inventor: Michael J. Wern, Alsip, IL (US)

(21) Appl. No.: 18/648,012

(22) Filed: Apr. 26, 2024

Related U.S. Application Data
(60) Provisional application No. 63/498,678, filed on Apr. 27, 2023.

(51) Int. Cl. B23Q 3/06; B23Q 3/154

(52) U.S. Cl. CPC B23Q 3/062; B23Q 3/1546

(57) ABSTRACT

A one-piece tooling apparatus configured to position two or more types of workpieces can be utilized in connection with a process on the workpieces. In particular, a one-piece tooling apparatus comprising a column comprising a hollow inner column adapted to receive an insert and an outer column, wherein the insert is adapted to support a workpiece to be processed, a base configured to affix the column to a part processing apparatus for processing the workpiece, and a platform coupled to the outer column adapted to support the workpiece to be processed.

### CROSS-REFERENCE TO RELATED APPLICATIONS

The present application claims the benefit of U.S. Provisional Patent Application Ser. No. 63/498,678, entitled “ONE-PIECE TOOLING APPARATUS,” filed Apr. 27, 2023, which is hereby incorporated herein by reference in its entirety and made part of the present U.S. Utility Patent Application for all purposes.

### FIELD OF INVENTION

The disclosure generally relates to processing workpieces, and more particularly to tooling for use with different workpieces.

### BACKGROUND

Specialized tooling may be required for the processing of a variety of workpieces (also referred to as a part). For example, in processes such as shot peening, blast finishing, and deburring, a workpiece can be arranged on tooling that positions the workpiece for processing and then be introduced to a machine or chamber. The machine or chamber performs a process on the workpiece, which is then removed and replaced with the next workpiece to be processed.

A challenge exists in the need to change tooling for different types of workpieces. For example, a single shot peening machine might be used to process a variety of gear types for a vehicle, such as a ring gear and a pinion gear. Such gears can have different parameters such as internal and external radiuses, widths, weights, et cetera, but must still be maintained in position on the tooling during movement and processing (such as peening or blasting) to ensure the process proceeds properly. As such, component-specific or multi-piece tooling can be used to properly arrange a workpiece, and maintain its arrangement, until processing is complete.

The use of component-specific or multi-piece tooling presents further challenges as it imposes and increases changeover time as different parts are used. Changing the parts themselves is laborious, and changing tooling adds to that burden. The expense of workpiece-specific tooling is magnified in automated environments, where workpiece changes require either a human changing the tooling before a robot resumes work or the development of a robot capable of handling tooling changes, increasing the expense and complexity of the robot.

Accordingly, it would be beneficial to develop a one-piece tooling apparatus capable of accommodating a variety of workpieces.

### SUMMARY

In an embodiment, a one-piece tooling apparatus may be configured to position two or more types of workpieces and can be utilized in connection with a process on the workpieces.

While this Summary describes certain aspects of the disclosure, many further alternative and complementary aspects will be understood on review of the disclosure in its entirety, and so this Summary should not be interpreted as in any way limiting the scope or spirit of the innovation described herein.

### BRIEF DESCRIPTION OF DRAWINGS

FIG. 1 shows example workpieces for use with tooling, in accordance with one or more embodiments.

FIG. 2A shows a bottom view of an example tooling apparatus, in accordance with one or more embodiments.

FIG. 2B shows a top view of the example tooling apparatus of FIG. 2A, in accordance with one or more embodiments.

FIG. 3 shows an example one-piece tooling apparatus, in accordance with one or more embodiments.

FIG. 4 shows example inserts for use with the one-piece tooling apparatus and example workpieces, in accordance with one or more embodiments.

FIG. 5 shows a cross-sectional diagram of an example one-piece tooling apparatus with no insert and supporting a flat workpiece, in accordance with one or more embodiments.

FIG. 6 shows a cross-sectional diagram of an example one-piece tooling apparatus with a shallow insert and supporting a flat workpiece, in accordance with one or more embodiments.

FIG. 7 shows a cross-sectional diagram of an example one-piece tooling apparatus with a shallow insert and supporting a flat workpiece, in accordance with one or more embodiments.

FIG. 8 shows a cross-sectional diagram of an example one-piece tooling apparatus with a shallow insert and supporting an elongated workpiece, in accordance with one or more embodiments.

FIG. 9 shows a cross-sectional diagram of an example one-piece tooling apparatus with a deep insert and supporting an elongated workpiece, in accordance with one or more embodiments.

While the above-identified figures set forth one or more embodiments, other embodiments are also contemplated and will be understood by those of ordinary skill in the art on review of this disclosure. Alternative embodiments, complementary aspects, and modifications will be understood as falling within the scope and spirit of the principles of the disclosed innovation. In all cases, this disclosure presents the illustrated embodiments by way of representation and not limitation.

### DETAILED DESCRIPTION

The present disclosure generally relates to one-piece tooling apparatuses for positioning a workpiece for processing. Processing can encompass a range of treatments including, but not limited to, shot peening, blast finishing, deburring, and similar procedures. In these processes, a workpiece may first be strategically positioned using specialized tooling to establish proper alignment and stability. Once secured, the workpiece may undergo the designated treatment, which may involve exposure to high-velocity projectiles, abrasive materials, or other finishing techniques aimed at enhancing the workpiece's surface properties and/or geometry. These processes are part of a broader spectrum of treatments familiar to skilled practitioners in the art, each tailored to improve the performance, durability, and/or aesthetic of the workpiece.

The one-piece tooling apparatus may serve as a versatile fixture that can be securely arranged or attached to machine or within a chamber. Whether the attachment is temporary or permanent, the one-piece tooling apparatus may streamline the process of handling diverse workpieces. An insert may or may not be used with the one-piece tooling, and holes toward the bottom of the column allow set screws to be employed to position or fix the insert if used. A platform (or main plate) is attached to or formed with the column, and the platform can have various elevations or steps to accommodate different workpiece geometries. The workpiece is positioned on the platform and/or the insert for processing.

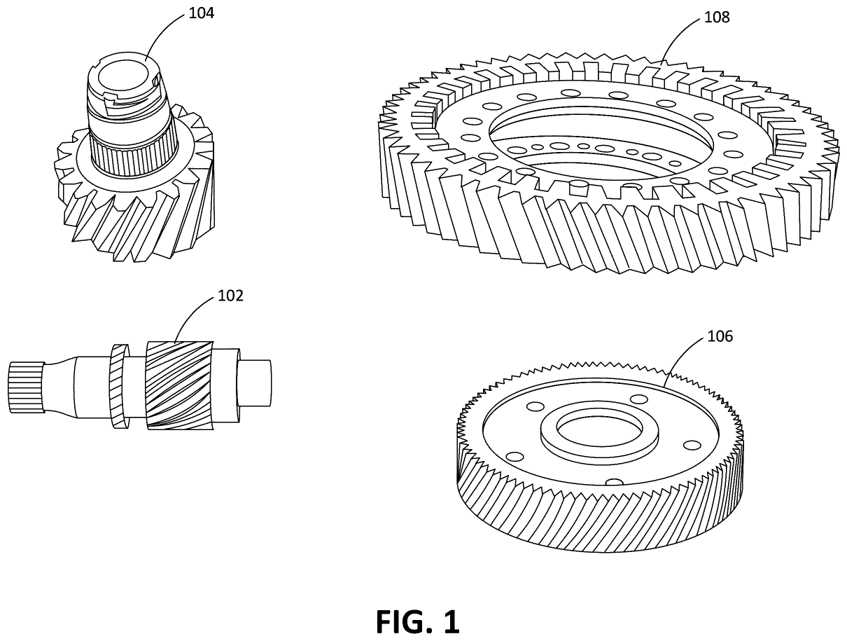

FIG. 1 illustrates a variety of example workpieces. The example workpieces shown are gears, but other workpieces can be used with the tooling described herein without departing from the scope or spirit of the innovation. As can be understood from FIG. 1, workpieces can have a variety of geometries and constructions, imposing different constraints on tooling. Gears 102, 104 are different sizes of elongated workpieces, such as gear shafts with helical gears characterized by their spiraled teeth designed for smooth engagement and operation. Gears 106, 108 are larger sizes of flat workpieces, such as helical gears with different bore diameters.

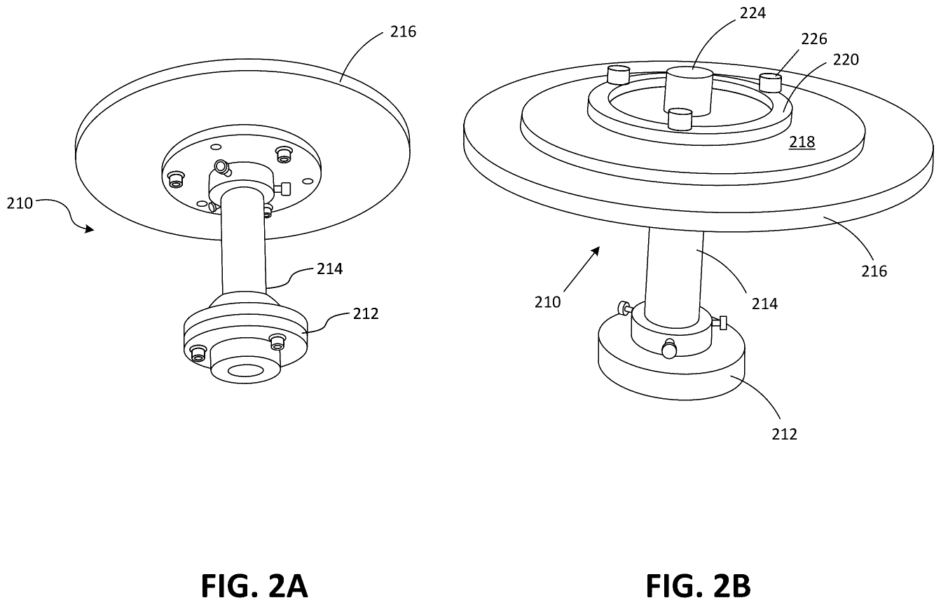

FIG. 2A illustrates an example tooling apparatus 210. The tooling apparatus 210 includes a shaft 214 that extends vertically from a flanged base 212. The base 212 may be designed to be mounted onto corresponding machinery, providing a stable axis of rotation to a fixed point of reference during the treatment. Above the shaft 214 includes a horizontally oriented platform 216 having a substantially flat surface and circumferentially arranged apertures. The tooling apparatus 210 utilize a narrow base 212 below a platform 216 for holding a workpiece. The platform 216 can be designed to accommodate a specific workpiece geometry or construction. However, the lack of adjustment mechanisms leaves the tooling apparatus 210 configured to handle only a limited range of workpieces. The tooling apparatus 210 may be replaced with one-piece tooling apparatuses for treating workpieces of different configurations.

FIG. 2B illustrates a top view of the example tooling apparatus 210. The tooling apparatus 210 includes base 212 for securing apparatus 210 for use (e.g., temporary or permanent attachment to a machine or processing system). The tooling apparatus 210 also includes a shaft 214 and platform 216. Platform 216 can include additional extensions or elevations, such as elevations 218 and 220, as well as post 224 and/or studs 226, to accommodate workpiece geometries. While platform 216, elevations 218 and 220, and post 224 are illustrated as concentric platters, and the three studs 226 are shown symmetrically arranged about platform 216 at a common radius, it is understood that other non-circular or asymmetric geometries may be used to accommodate particular workpieces.

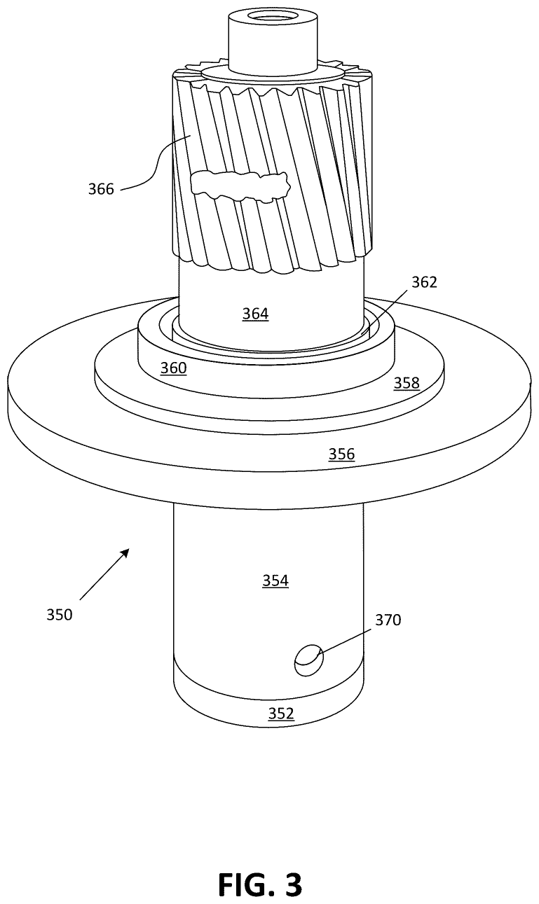

FIG. 3 illustrates an example one-piece tooling apparatus 350. The one-piece tooling apparatus 350 includes a base 352 for securing the one-piece tooling apparatus 350 for use. For example, the base 352 may be clamped, bolted, or otherwise secured, temporarily or permanently, to a machine or processing system.

Unlike the tooling apparatus 210, the one-piece tooling apparatus 350 includes a hollow column 354. Column 354 can be hollow and sized to accommodate various inserts, such as insert 364, which can be tailored to the requirements of the workpiece 366 or the processing task. In embodiments, column 354 can include one or more set screw holes 370 for securing the insert 364 when inserted into the column 354. The screw holes 370 may be strategically placed to facilitate the secure positioning of inserts that may have diverse geometrical configurations. The screw holes 370 may be threaded apertures for set screws and/or may be configured to utilize other locking mechanisms, such as ball-lock pins (e.g., on the insert 364) for rapid insert changes.

Atop the column 354 is platform 356. The platform 356 may include one or more elevations, such as elevations 358 and 360. The stepped elevations can enhance the functionality of the platform 356, providing a range of surfaces upon which workpieces of varying dimensions and shapes can be supported. In some embodiments, the platform 356 is a predetermined distance below the top of the column 354 such that the top of the column is another elevation.

The one-piece tooling apparatus 350 can also include inner column 362, which receives and align inserts such as insert 364. The inner column 362 can vary in its internal and/or external dimensions (e.g., diameters), which could be smaller, larger, or approximately equivalent to the dimensions of the column 354, offering additional adaptability in the accommodation of inserts of varying sizes.

While the illustrated embodiment includes circular, symmetrical geometries, it is understood that non-circular and/or asymmetrical geometries may be used without departing from the scope or spirit of the innovation. For example, the one-piece tooling apparatus 350 could have a polygonal column or platform 356, and/or utilize polygonal inserts, without departing from the scope or spirit of the disclosure.

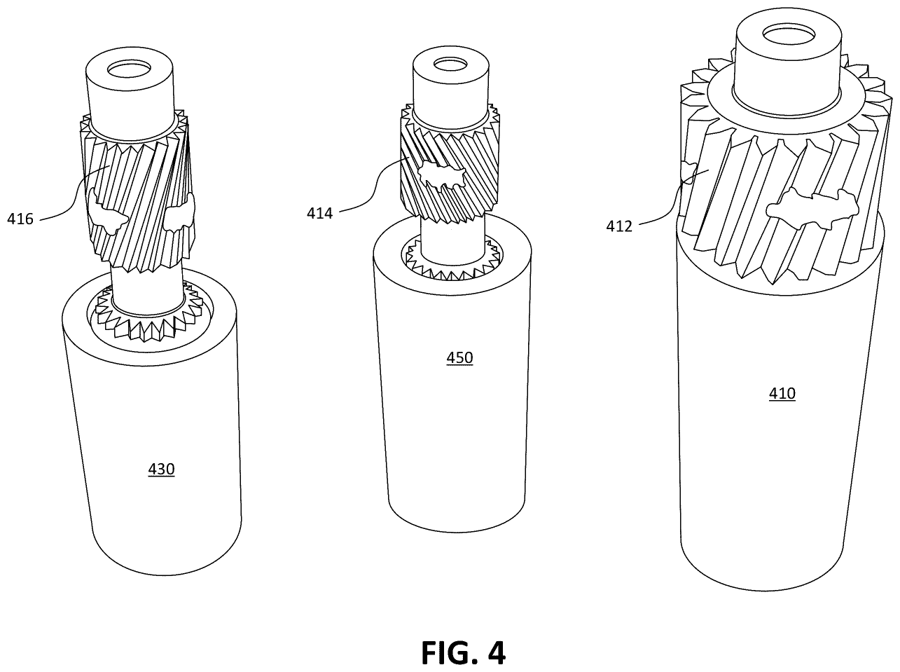

FIG. 4 illustrates example inserts 410, 430, and 450 for use with a one-piece tooling apparatus (e.g., one-piece tooling apparatus 350). The inserts 410, 430, and 450 can be used to provide a straightforward solution for adapting the one-piece tooling apparatus to different workpiece geometries and constructions, thereby obviating the need for cumbersome tooling exchanges and streamlining the treatment process.

The inserts can be made of, e.g., polymers, making them light and easy to handle and install. Their polymeric nature also offers economic advantages due to lower material costs and streamlined manufacturing process inexpensive to make or procure. By using polymers and/or other similar materials, damage to the workpiece can be prevented as the inserts will not scratch or dent such workpieces.

The inserts 410, 430, and 450 can have outer and/or inner dimensions (e.g., diameters) sized to securely accommodate one or more workpiece types, such as shown in FIG. 4. In some embodiments, an insert can have two or more inner diameters with portions bored to different dimensions. This multi-diameter design allows an insert to accommodate workpieces of different geometries at different depths or on different positions on or in the insert, thus optimizing the use of space of the insert.

The inserts 410, 430, and 450 can also or instead have heights corresponding to particular workpieces. Such variability in insert height allows for the accommodation of workpieces that may have irregular features, such as protrusions or recesses, by providing appropriate levels of support where at particular locations of the workpiece. This may help in maintaining the stability of the workpiece during high-precision tasks, thereby helping maintain the integrity of the machining or processing operation. For example, the insert 410 may be tall enough to cover the workpiece 412 such that only the teeth of the end portion of the workpiece are exposed and thus subject to processing, the insert 450 may be tall enough to cover half of the workpiece 414, exposing the some of the teeth as well as some of the shaft of the workpiece, and the insert 430 may be short enough to expose all of the teeth of the workpiece 416 while still holding the workpiece steady.

While the illustrated embodiments include circular, symmetrical geometries, it is understood that non-circular and/or asymmetrical geometries may be used without departing from the scope or spirit of the innovation. For example, an insert may have polygonal geometries without departing from the scope or spirit of the disclosure.

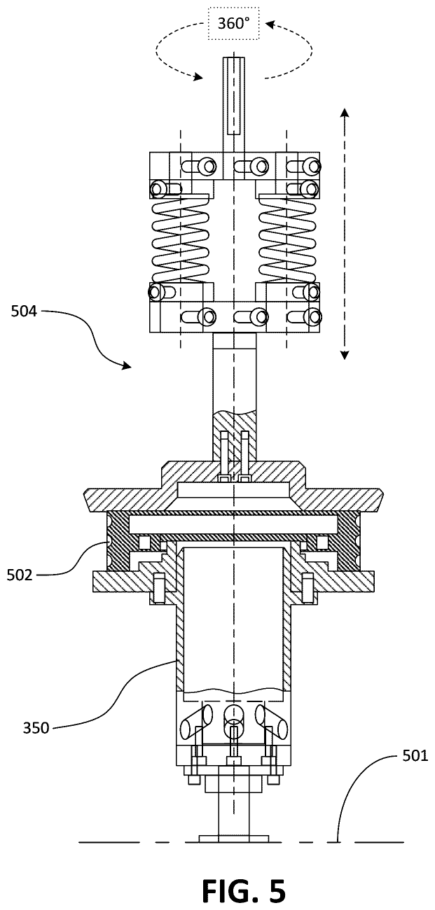

FIG. 5 shows a cross-sectional diagram of the one-piece tooling apparatus 350 with no insert and supporting a flat workpiece 502. The one-piece tooling apparatus 350 may be assembled from multiple pieces as illustrated (e.g., with through-holes and screws or other hardware between the base and column and between the column and platform), but in alternative embodiments, the one-piece tooling apparatus 350 may be formed monolithically of a single piece of material (e.g., metal). The one-piece tooling apparatus 350 may be secured to a surface 501, which may be part of a broad workpiece processing apparatus.

The workpiece 502 may be formed such that it rests on the platform (e.g., platform 356) of the one-piece tooling apparatus 350. The workpiece 502 may be held securely by a downward pressure from a part hold down apparatus 504, such as a double spring hold down apparatus as described by U.S. Pat. Nos. 11,045,915 and 11,458,580, which are both incorporated by reference herein.

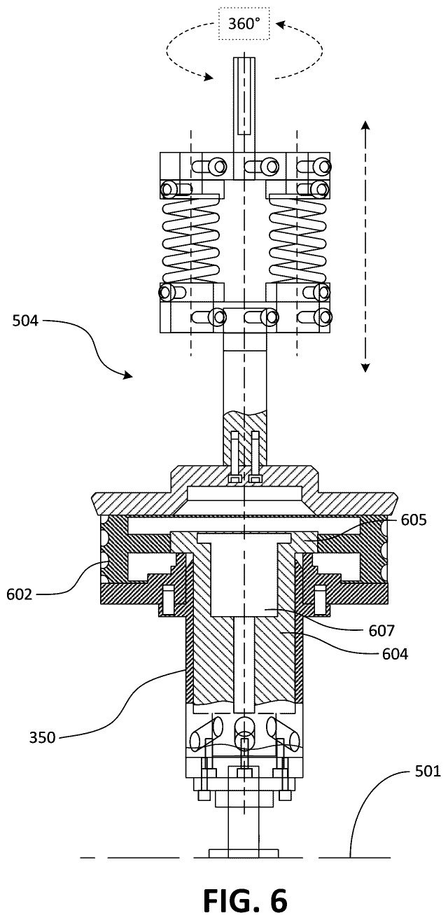

FIG. 6 shows a cross-sectional diagram of the one-piece tooling apparatus 350 with a shallow insert 604 and supporting a flat workpiece 602. The workpiece 602 may be formed such that it rests on the platform (e.g., platform 356) of the one-piece tooling apparatus 350. However, due to the structure of the workpiece 602, the platform may not provide sufficient lateral support for the workpiece 602 during processing. In such a scenario, an insert 604 may be utilized to provide additional support for the workpiece 602. As shown in the figure, the insert 604 is shallow meaning that its structure defines a cavity 607 that has a depth less than half the height of the shallow insert 604. The shallow insert 604 may include an annular step 605 that has a height sufficient to provide additional lateral support for the workpiece 602 during processing.

Between processing workpiece 502 and workpiece 602, a user may simply remove the workpiece 502, place the shallow insert 604 in the one-piece tooling apparatus 350, and place the workpiece 602 on the platform of the one-piece tooling apparatus 350.

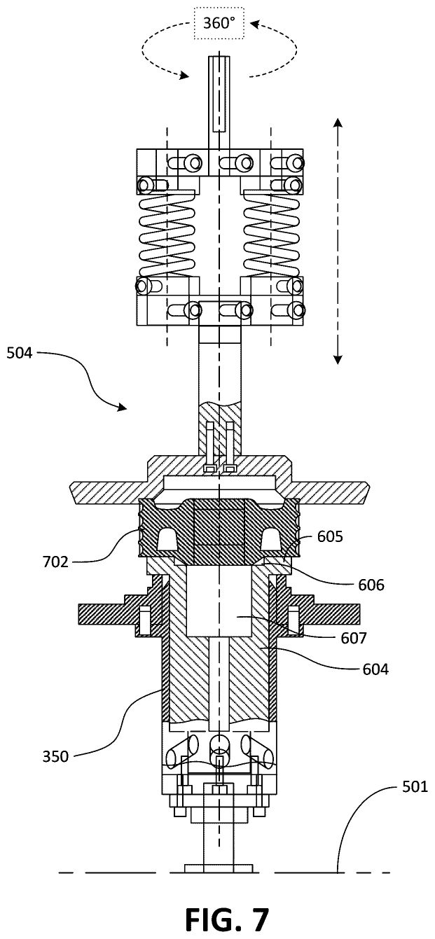

FIG. 7 shows a cross-sectional diagram of the one-piece tooling apparatus 350 with the shallow insert 604 and supporting a flat workpiece 702. A challenge may arise when dealing with parts of a minimal size. For example, the flat workpiece 702 may not have sufficient surface area to be securely positioned on the platform of the one-piece tooling apparatus 350, and there may be a risk of the flat workpiece 702 descending into the hollow column (e.g., column 354) that may be used for receiving the various inserts.

To ameliorate this issue, the shallow insert 604 (or any other purpose-built insert) may be employed. The shallow insert 604 may have a dual-purpose design. The upper section of the shallow insert 604 may have a support surface 606 for the small flat workpiece 702 to rest upon during processing. The support surface 606 may be defined by the annular step 605, and the annular step 605 may function as a barrier that contains the flat workpiece 702, preventing lateral movement that could lead to displacement of the flat workpiece 702. For example, when the one-piece tooling apparatus 350 is in motion, centrifugal forces may come into play, and annular step 605 may serve as a retentive feature that secures the flat workpiece 702 in place, counteracting those forces that may cause displacement of the flat workpiece 702. The shallow insert 604 may also be crafted with a cavity 607 to receive and support workpieces, thereby allowing the one-piece tooling apparatus 350 to support workpieces that rest upon the one-piece tooling apparatus 350 (e.g., flat workpiece 702) as well as workpieces that are inserted into the one-piece tooling apparatus 350 (e.g., via the cavity 607).

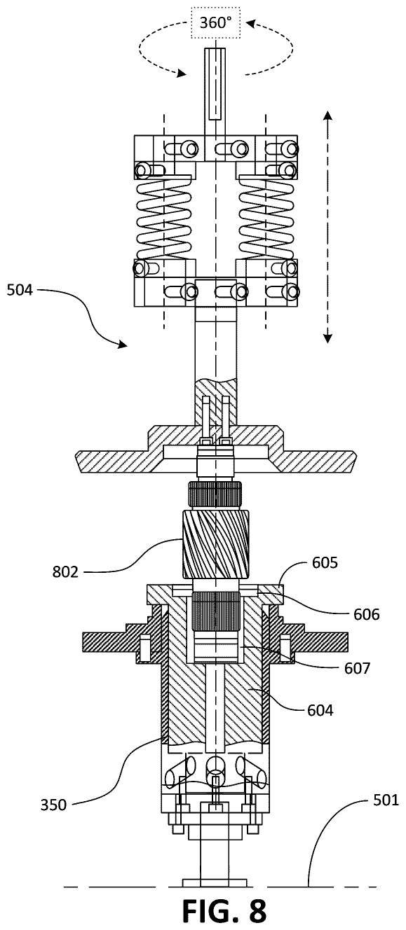

FIG. 8 shows a cross-sectional diagram of the one-piece tooling apparatus 350 with the shallow insert 604 and supporting an elongated workpiece 802. To facilitate the seamless changing of workpieces (e.g., from the flat workpiece 702 to the elongated workpiece 802), the shallow insert 604 may be crafted with a cavity 607. The cavity 607 may be of a lesser diameter beneath the support surface 606. The cavity 607 may be designed to securely house elongated workpieces, which may be processed prior or subsequent to the flat workpiece 702. Rather than replacing the entire tooling apparatus and the workpiece, only the workpieces may be replaced, and a greater variety of workpieces may be supported based on the insert and/or the one-piece tooling.

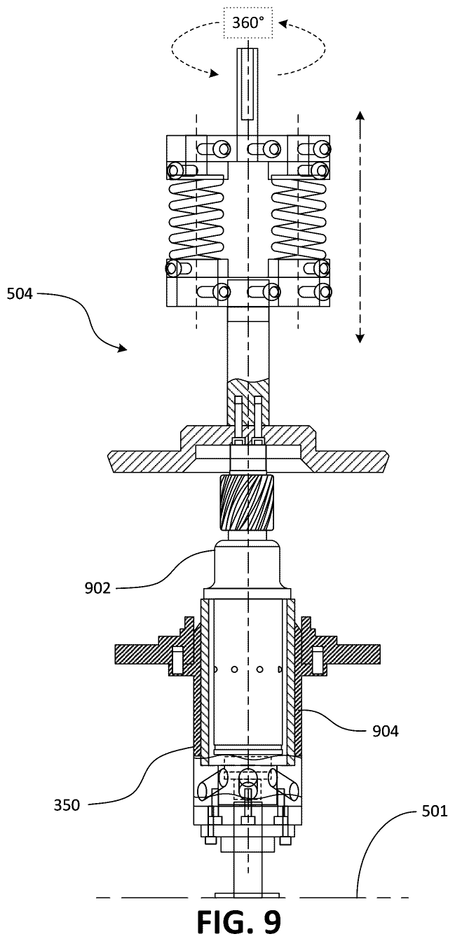

FIG. 9 shows a cross-sectional diagram of the one-piece tooling apparatus 350 with a deep insert 904 and supporting an elongated workpiece 902. If the elongated workpiece 902 is not compatible with an insert (e.g., shallow insert 604), the user may simply replace the insert with the deep insert 904, which is compatible with the elongated workpiece 902.

As shown in the figure, the deep insert 904 may be retained in the one-piece tooling apparatus 350 merely by the weight of the elongated workpiece 902 and/or the hold down apparatus 504. Upon removal of a processed workpiece (e.g., elongated workpiece 802), an insert (e.g., shallow insert 604) can be lifted directly out of the one-piece tooling apparatus 350 (e.g., column 354), in some embodiments, without the need for tools. The deep insert 904 may then simply be positioned into the one-piece tooling apparatus 350, and the weight of the elongated workpiece 902 and/or the hold down apparatus 504 may be used once again to maintain the position of the deep insert 904.

The hold down apparatus 504 may include hydraulic or pneumatic clamping systems that utilizes fluid power to exert force on an insert (e.g., via the workpiece), clamping the insert and/or a workpiece in place. The replacement process may involve activating a release valve, which reduces the clamping pressure and allows the insert and/or workpiece to be replaced. Once the new insert (e.g., the deep insert 904) is in place, the hold down apparatus 504 may be re-activated to secure the insert and/or the workpiece under pressure of the hold down apparatus.

Additionally or alternatively, replacing the insert may involve adjusting one or more fasteners. For example, when an insert is secured by set screws, the set screws may be loosened (e.g., with an Allen key or a similar tool), which allows the insert to be removed from its fixed position. Once loosened, the insert (e.g., shallow insert 604) can be extracted with minimal effort. The deep insert 904 may then be aligned with the column of the one-piece tooling apparatus 350, placed into position, and secured by re-tightening the set screws, so that the deep insert 904 is firmly anchored for the next process.

Additionally or alternatively, the insert (e.g., deep insert 904) may be outfitted with magnetic materials that adhere to the metallic components of the one-piece tooling apparatus 350 and/or the workpiece 902. To replace a magnetically secured insert (e.g., shallow insert 604), one would apply a counteracting force to overcome the magnetic attraction and remove the insert. The new insert (e.g., deep insert 904) may then be placed, and the magnetic force re-engages to secure it.

Additionally or alternatively, other insert retention mechanisms may be employed, aside from screws and/or magnets. The retention mechanism could involve a bayonet mount, where the insert is locked in place with a partial twist, or a cam-lock system, where a lever or knob activates a cam to clamp or release the insert. These designs allow for rapid insert changes, reducing machine downtime and maintaining production flow, while maintaining the simplicity of the one-piece tooling apparatus 350.

The one-piece tooling apparatuses described herein can be used in semi- or fully-automated facilities and are compatible with robots or machines that switch workpieces before or after processing (and, in embodiments, inserts) or otherwise aid in processing workpieces or maintaining equipment. The one-piece tooling apparatuses described herein may be used in cooperation with a double spring workpiece hold down apparatus (e.g., apparatus 504).

As numerous modifications and variations will readily occur to those skilled in the art, nothing herein is intended to limit the disclosure to the exact construction and operation illustrated and described, and accordingly all suitable modifications and equivalents are regarded as falling within the scope of the disclosure. It is further intended that all such aspects be coverable by claims, although no specific claim need necessarily cover any particular aspect not recited therein.

What is claimed is:

1. A one-piece tooling apparatus comprising:
a column comprising a hollow inner column adapted to receive an insert and an outer column, wherein the insert is adapted to support a workpiece to be processed;
a base configured to affix the column to a part processing apparatus for processing the workpiece; and
a platform coupled to the outer column adapted to support the workpiece to be processed.

2. The one-piece tooling apparatus of claim 1, wherein the platform comprises one or more elevations for supporting the workpiece to be processed.

3. The one-piece tooling apparatus of claim 2, wherein the one or more elevations of the platform together form a stepped elevation.

4. The one-piece tooling apparatus of claim 1, wherein the insert comprises a cavity adapted to receive at least some of the workpiece to be processed.

5. The one-piece tooling apparatus of claim 1, wherein the insert comprises a support surface, the support surface is defined by an annular step and is adapted to provide support over the hollow inner column for at least some of the workpiece to be processed.

6. The one-piece tooling apparatus of claim 1, wherein the column comprises one or more holes adapted to receive one or more fasteners for retaining the insert in the hollow inner column, the one or more holes passing from the outer column through the inner column.

7. The one-piece tooling apparatus of claim 1, wherein the hollow inner column comprises one or more magnets having an exposed first polarity and the insert comprises one or more corresponding magnets having an exposed second polarity, wherein the exposed first polarity and the exposed second polarity retain the insert within the hollow inner column.

8. The one-piece tooling apparatus of claim 1, wherein the one-piece tooling apparatus is metallic and the insert is polymeric.

9. The one-piece tooling apparatus of claim 1, wherein the platform is adapted to receive a downward pressure from a part hold down apparatus of the part processing apparatus.

10. A method for manufacturing a one-piece tooling apparatus comprising:
forming, from one or more pieces of a first material, a column comprising a hollow inner column adapted to receive an insert and an outer column, wherein the insert is adapted to receive a workpiece to be processed and the insert is formed from one or more pieces of a second material;
forming, from the one or more pieces of the first material, a base configured to affix the column to a part processing apparatus for processing the workpiece; and
forming, from the one or more pieces of the first material, a platform coupled to the outer column adapted to support the workpiece to be processed.

11. The method for manufacturing the one-piece tooling apparatus of claim 10, wherein the platform comprises one or more elevations for supporting the workpiece to be processed, the one or more elevations formed from the platform.

12. The method for manufacturing the one-piece tooling apparatus of claim 11, wherein the one or more elevations of the platform together form a stepped elevation.

13. The method for manufacturing the one-piece tooling apparatus of claim 10, wherein the insert is formed to comprise a cavity adapted to receive at least some of the workpiece to be processed.

14. The method for manufacturing the one-piece tooling apparatus of claim 10, wherein the insert is formed to comprise a support surface, the support surface is defined by an annular step and is adapted to provide support over the hollow inner column for at least some of the workpiece to be processed.

15. The method for manufacturing the one-piece tooling apparatus of claim 10, wherein the column is formed to comprise one or more holes adapted to receive one or more fasteners for retaining the insert in the hollow inner column, the one or more holes passing from the outer column through the inner column.

16. The method for manufacturing the one-piece tooling apparatus of claim 10, wherein the hollow inner column is formed to comprise one or more magnets having an exposed first polarity and the insert is formed to comprise one or more corresponding magnets having an exposed second polarity, wherein the exposed first polarity and the exposed second polarity retain the insert within the hollow inner column.

17. The method for manufacturing the one-piece tooling apparatus of claim 10, wherein the first material is metal and the second material is a polymer.

18. The method for manufacturing the one-piece tooling apparatus of claim 10, wherein the platform is formed to receive a downward pressure from a part hold down apparatus of the part processing apparatus.

19. A one-piece tooling apparatus comprising:
a column, formed from a first material, comprising a hollow inner column adapted to receive an insert, formed from a second material, and an outer column, wherein the column comprises one or more holes adapted to receive one or more fasteners for retaining the insert in the hollow inner column, the insert is adapted to support a workpiece to be processed, the insert comprises a cavity adapted to receive at least some of the workpiece to be processed;
a base, formed from the first material, configured to affix the column to a part processing apparatus for processing the workpiece; and
a platform, formed from the second material, coupled to the outer column adapted to support the workpiece to be processed, wherein the platform comprises one or more elevations for supporting the workpiece to be processed.

20. The one-piece tooling apparatus of claim 19, wherein the platform is adapted to receive a downward pressure from a part hold down apparatus of the part processing apparatus via the workpiece to be processed.
